(19) United States
(12) Patent Application Publication
(10) Pub. No.: US 2026/0291291 A1
(43) Pub. Date: Sep. 24, 2026

(54) TERMINAL AND POWER TRANSFER METHOD19148735

(71) Applicant: NTT DOCOMO, INC., Tokyo (JP)

(72) Inventors: Shohei Yoshioka, Chiyoda-ku, Tokyo (JP); Mayuko Okano, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 19/153,077

(22) PCT Filed: Mar. 28, 2023
(86) PCT No.: PCT/JP2023/012702

§ 371 Date: Aug. 1, 2025

(51) Int. Cl. H02J 50/80; H02J 50/20; H04W 52/02

(52) U.S. Cl. CPC H02J 50/80; H04W 52/0212; H02J 50/20

(57) ABSTRACT

A terminal includes: a communication unit configured to receive, from a base station, an indication related to power transfer; a power receiving unit configured to receive wireless power transfer, according to the indication related to power transfer; and a control unit configured to determine, according to a function to reduce power consumption, whether or not to carry out an operation related to power transfer.

### FIELD OF THE INVENTION

The present invention relates to a terminal and a power transfer method for use in a wireless communication system.

### BACKGROUND OF THE INVENTION

The requirements of “new radio” (NR, also referred to as “5G”), which is a successor system of long-term evolution (LTE), include large system capacity, high data transmission speed, low latency, simultaneous access from multiple terminals, low cost, power saving, and so forth, and a variety of techniques are under study to meet these requirements (see, for example, non-patent document 1).

In LTE and NR, Internet-of-things (IoT) user equipment (UE) categories or UE capabilities are set forth such that the technical details that regular terminals support on a mandatory basis, such a. s transmitting/receiving bands, the number of antennas, etc., are reduced. For example, LTE supports enhanced machine-type communication (eMTC) and narrow band IoT (NB-IoT), and NR supports reduced capabilities (RedCap).

In recent years, interest in wireless power transfer technology has been growing, and power transfer methods for a variety of devices, including IoT terminals, are being actively studied. For example, according to a study that is underway, a specific frequency band is allocated for wireless power transfer, whether the use of wireless power transfer has impact on the human body, whether it creates radio interference with other communication devices, and so forth are analyzed, and, if the use of wireless power transfer proves harmless, its range of use is expanded to outdoors and spaces with people, etc.

Furthermore, 3GPP (registered trademark) is discussing standardization of ultra-low power terminals, which presumes the use of wireless power transfer using environmental means such as sunlight, wind, water, electromagnetism, heat, sound, vibration, etc. (see, for example, non-patent document 2).

### RELATED-ART DOCUMENTS

### Non-Patent Documents

Non-Patent Document 1: 3GPP TS 38.300 V17.3.0 (2022-12)
Non-Patent Document 2: 3GPP TR 22.840 V1.0.0 (2022-12)

### SUMMARY OF THE INVENTION

### Technical Problem

There is a growing need to link a terminal's function to reduce power consumption while communication is in progress, with a wireless power transfer function. The purpose of having a wireless power transfer function is to increase the terminal's remaining battery power, and, provided that the communication function is a major cause of decrease in the remaining battery power of the terminal, the remaining battery power may be increased efficiently by linking the function to reduce power consumption with the wireless power transfer function appropriately.

The present invention has been made in view of the foregoing and aims to reduce terminal power consumption and carry out wireless power transfer in a wireless communication system.

### Solution to Problem

According to the technique disclosed herein, a terminal is provided. This terminal includes: a communication unit configured to receive, from a base station, an indication related to power transfer; a power receiving unit configured to receive wireless power transfer, according to the indication related to power transfer; and a control unit configured to determine, according to a function to reduce power consumption, whether or not to carry out an operation related to power transfer.

### Advantageous Effects of Invention

According to the technique disclosed herein, it is possible to reduce terminal power consumption and carry out wireless power transfer in a wireless communication system.

### BRIEF DESCRIPTION OF THE DRAWINGS

FIG. 1 is a diagram showing an example structure of a wireless communication system;

FIG. 2 is a diagram showing an example architecture (1) of wireless power transfer according to an embodiment of the present invention;

FIG. 3 is a diagram showing an example architecture (2) of wireless power transfer according to an embodiment of the present invention;

FIG. 4 is a sequence diagram for explaining an example of wireless power transfer according to an embodiment of the present invention;

FIG. 5 is a diagram for explaining an example (1) of reducing power consumption;

FIG. 6 is a diagram for explaining an example (2) of reducing power consumption;

FIG. 7 is a diagram for explaining an example (3) of reducing power consumption;

FIG. 8 is a diagram for explaining an example (4) of reducing power consumption;

FIG. 9 is a diagram for explaining an example (5) of reducing power consumption;

FIG. 10 is a diagram for explaining an example (6) of reducing power consumption;

FIG. 11 is a diagram for explaining an example (7) of reducing power consumption;

FIG. 12 is a diagram for explaining an example (8) of reducing power consumption;

FIG. 13 is a diagram for explaining an example (9) of reducing power consumption;

FIG. 14 is a diagram showing an example (1) of wireless power transfer according to an embodiment of the present invention;

FIG. 15 is a diagram showing an example (2) of wireless power transfer according to an embodiment of the present invention;

FIG. 16 is a diagram showing an example (3) of wireless power transfer according to an embodiment of the present invention;

FIG. 17 is a diagram showing an example (4) of wireless power transfer according to an embodiment of the present invention;

FIG. 18 is a diagram showing an example functional structure of a base station 10 according to an embodiment of the present invention;

FIG. 19 is a diagram showing an example functional structure of a terminal 20 according to an embodiment of the present invention;

FIG. 20 is a diagram showing an example hardware structure of a base station 10 or a terminal 20 according to an embodiment of the present invention; and

FIG. 21 is a diagram showing an example structure of a vehicle 2001 according to an embodiment of the present invention.

### DETAILED DESCRIPTION OF THE PREFERRED EMBODIMENTS

Now, an embodiment of the present invention will be described below with reference to the accompanying drawings. Note that the embodiment described below is only an example, and the applicability of the present invention is by no means limited to the following embodiment.

Existing techniques may be used as appropriate to operate the wireless communication system according to the following embodiment of the present invention. Examples of such techniques include, but are not limited to, existing LTE. Also, unless otherwise specified, the term “LTE” as used herein has a broad meaning, covering LTE-Advanced and systems that emerged after LTE-Advanced (for example, NR, 6G wireless standards, etc.).

Also, in the following description of an embodiment of the present invention, terms that are used in existing LTE will be used, including “synchronization signal (SS)”, “primary SS (PSS)”, “secondary SS (SSS)”, “physical broadcast channel (PBCH)”, “physical random access channel (PRACH)”, “physical downlink control channel (PDCCH)”, “physical downlink shared channel (PDSCH)”, “physical uplink control channel (PUCCH)”, “physical. uplink shared channel (PUSCH)”, and so forth. The use of these terms is for ease of description, and signals, functions, and so forth that are the same or substantially the same as these may be referred to by other names. For example, in NR, the above terms correspond to “NR-SS”, “NR-PSS”, “NR-SSS”, “NR-PBCH”, “NR-PRACH”, and so forth. The signals used in NR might not be always written with the prefix “NR-”.

Also, in the following embodiment of the present invention, the duplex method may be time division duplex (TDD), frequency division duplex (FDD), or any other method (including flexible duplex, for example).

Also, in the following embodiment of the present invention, when a radio parameter or the like is “configured”, this may mean that a predetermined value is configured in advance (or “pre-configured”), or mean that a radio parameter or the like that is indicated from a base station 10 or a terminal 20 is configured.

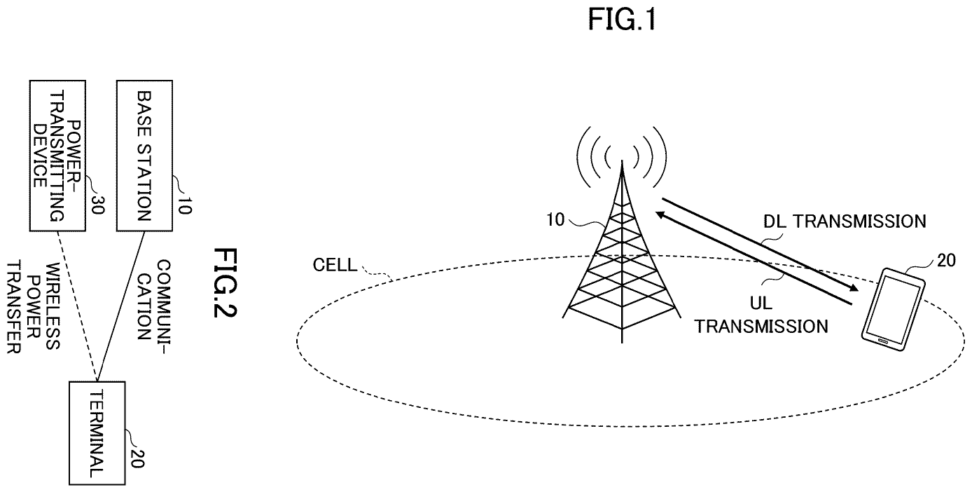

FIG. 1 is a diagram showing an example structure (1) of a wireless communication system according to an embodiment of the present invention. As shown in FIG. 1, according to an embodiment of the present invention, a wireless communication system includes a base station 10 and a terminal 20. Although one base station 10 and one terminal 20 are shown in FIG. 1, this is just one example, and there may be two or more of each.

The base station 10 is a communication device that provides one or more cells and communicates with the terminal 20 via wireless means. Physical resources for radio signals are given in the time domain and the frequency domain. The time domain resources may be indicated by the number of orthogonal frequency division multiplexing (OFDM) symbols, and the frequency domain resources may be indicated by the number of subcarriers or resource blocks. The base station 10 transmits synchronization signals and system information to the terminal 20. The synchronization signals include, for example, NR-PSS and NR-SSS. The system information is transmitted, for example, on NR-PBCH, and is also referred to as “broadcast information”. The synchronization signals and system information may be referred to as “SS/PBCH block” (SSB). Referring to FIG. 1, the base station 10 transmits control signals or data to the terminal 20 via downlink (DL), and receives control signals or data from the terminal 20 via uplink (UL). Both the base station 10 and the terminal 20 can transmit and receive signals by using beamforming. Also, both the base station 10 and the terminal 20 can apply multiple-input multiple-output (MIMO) communication to DL or UL. Also, the base station 10 and the terminal 20 may both communicate via a secondary cell (SCell) and a primary cell (PCell) in carrier aggregation (CA). Furthermore, in the event dual connectivity (DC) is deployed, the terminal 20 may communicate via a primary cell of the base station 10 and a primary secondary cell group cell (PSCell: Primary SCG Cell) of another base station 10.

The terminal 20 is a communication device with a wireless communication function, such as smartphone, a mobile phone, a tablet, a wearable terminal, or a machine-to-machine (M2M) communication module. As shown in FIG. 1, the terminal 20 receives control signals or data from the base station 10 via DL, and transmits control signals or data to the base station 10 via UL, thereby using various communication services provided by the wireless communication system. Also, the terminal 20 receives various reference signals transmitted from the base station 10 and measures the quality of propagation paths based on the result of receiving these reference signals.

The terminal 20 is able to communicate with the base station 10 in carrier aggregation, in which multiple cells (multiple component carriers (CCs)) are bundled. In carrier aggregation, one primary cell (PCell) and one or more secondary cells (SCells) are used. A PUCCH-SCell with PUCCH may also be used.

Accompanying the spread of a wide variety of devices (e.g., IoT terminals), methods for charging or replacing batteries in a huge number of terminals are under study. In recent years, interest in wireless power transfer (WPT) technology has increased, and power transfer methods for a variety of devices, including IoT terminals, are being actively studied.

For example, for IoT terminals, wireless power transfer is being studied from the standpoint of cost and battery replacement. For handheld terminals, wireless power transfer is being studied from the standpoint of cost and terminal size/shape. If highly efficient and high-capacity wireless power transfer becomes possible, it is expected that terminals will become even more advanced and diversified.

For example, according to a study that is underway, a specific frequency band is allocated for wireless power transfer, whether the use of wireless power transfer has impact on the human body, whether it creates radio interference with other communication devices, and so forth are analyzed, and, if the use of wireless power transfer proves harmless, its range of use is expanded to outdoors and spaces with people, etc.

Furthermore, 3GPP (registered Trademark) is discussing standardization of ultra-low power terminals, which presumes the use of wireless power transfer using environmental means such as sunlight, wind, water, electromagnetism, heat, sound, vibration, etc. (see, for example, non-patent document 2). Wireless power transfer will eliminate the need for battery charging, cable charging, or battery replacement.

Power may be transferred, via wireless means, to the terminal 20 from the base station 10 or from a power-transmitting device 30 connected to the base station 10. For example, the base station 10 to transmit power to the terminal 20 and the base station 10 to transmit and receive data may be the same base station 10 or different base stations 10.

The device that transfers power, that is, the power-transmitting device 30, may have the following characteristics (1) to (3):
(1) As for the type of the power-transmitting device 30, a device that is equivalent to a base station, an integrated access backhaul (IAB) node, a repeater, a re-configurable intelligent surface (RIS) node, a transmission/reception point (TRP), or a terminal may be used, or a power transmission device function may be provided separately.
(2) The base station, IAB node, repeater, RIS node, TRP, or terminal, etc. that carries out wireless power transfer may have a full duplex function.
(3) The IAB node, repeater, RIS node, TRP, or terminal, etc. that carries out wireless power transfer may or may not be connected with a base station while transferring power.

Note that the terms “power-transmitting device”, “base station”, “IAB node”, “repeater”, “RIS node”, “TRP”, and “terminal” may all be interchangeable.

The terminal 20 that receives transfer of power may have the following characteristics (1) to (3):
(1) The terminal 20 may move or may be fixed at a location.
(2) The terminal 20 may or may not have a capability to connect with the base station, IAB node, repeater, RIS node, TRP, terminal, etc. to communicate data.
(3) Regarding the type or the shape of the terminal 20, the terminal 20 may be, but is not limited to, a handheld terminal (a smartphone, a tablet, etc.), an IoT terminal (a sensor, a wearable terminal, a surveillance camera, a smart device, a home appliance, etc.), an ambient IoT terminal (a tag, a card, etc.), a robot, a drone, an electric vehicle, a personal Computer (PC), etc.

FIG. 2 is a diagram showing an example architecture (1) of wireless power transfer according to an embodiment of the present invention. As shown in FIG. 2, the power-transmitting device 30 may be installed separately from the base station 10 and transfer power to the terminal 20 via wireless means. The base station 10 may communicate with the terminal 20 and control the wireless power transfer by the power-transmitting device 30. The power-transmitting device 30 may be installed on a wall, a ceiling, etc. when used indoors, or on a utility pole, a street light, etc. when used outdoors. Also, the terminal 20 may work as a power-transmitting device 30 and transfer power to another terminal 20 via wireless means. Hereinafter, wireless power transfer to a terminal 20 from a power-transmitting device 30 not included in a base station 10 will interchangeably be referred to as wireless power transfer from a base station 10 to a terminal 20.

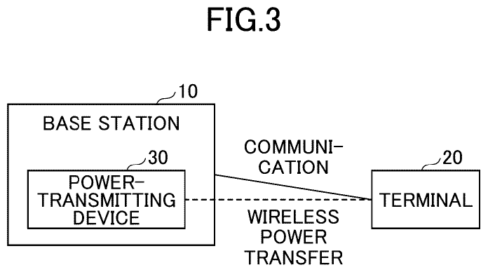

FIG. 3 is a diagram showing an example architecture (2) of wireless power transfer according to an embodiment of the present invention. As shown in FIG. 3, the power-transmitting device 30 may be installed together with a base station 10 and transfer power to a terminal 20 via wireless means. The base station 10 may communicate with the terminal 20 and control the wireless power transfer by the power-transmitting device 30. Hereinafter, wireless power transfer to a terminal 20 from a power-transmitting device 30 included in a base station 10 will interchangeably be referred to as wireless power transfer from a base station 10 to a terminal 20.

Now, there is a growing need to link a terminal's function to reduce power consumption while communication is in progress, with a wireless power transfer function. The purpose of having a wireless power transfer function is to increase the remaining battery power of the terminal 20, and, provided that the communication function is a major cause of decrease in the remaining battery power of the terminal 20, the remaining battery power may be increased efficiently by linking the function to reduce power consumption with the wireless power transfer function appropriately.

The terminal 20, to which power is transferred from a power-transmitting device via wireless means, may carry out a power-receiving operation according to a function “F”, which allows the terminal 20 to reduce its power consumption.

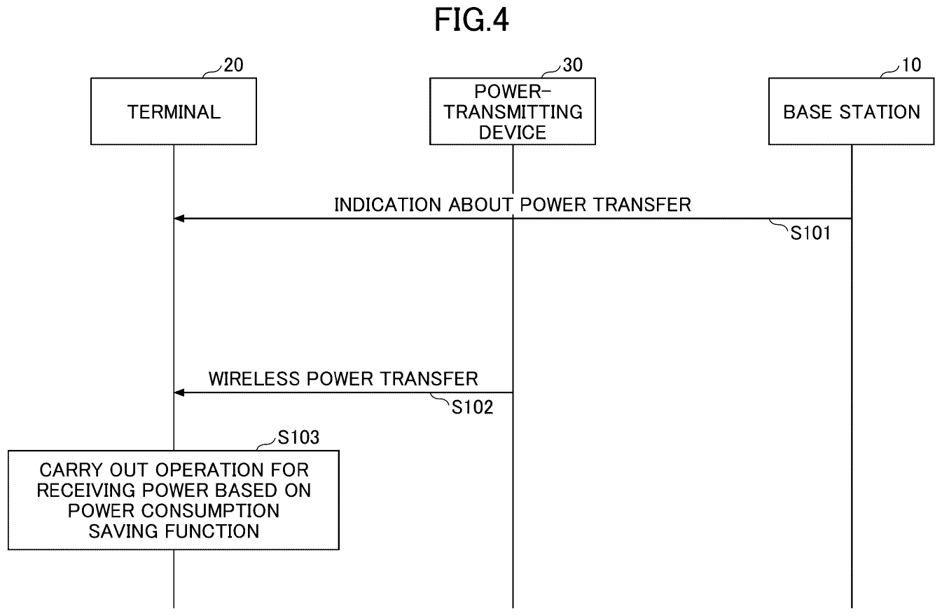

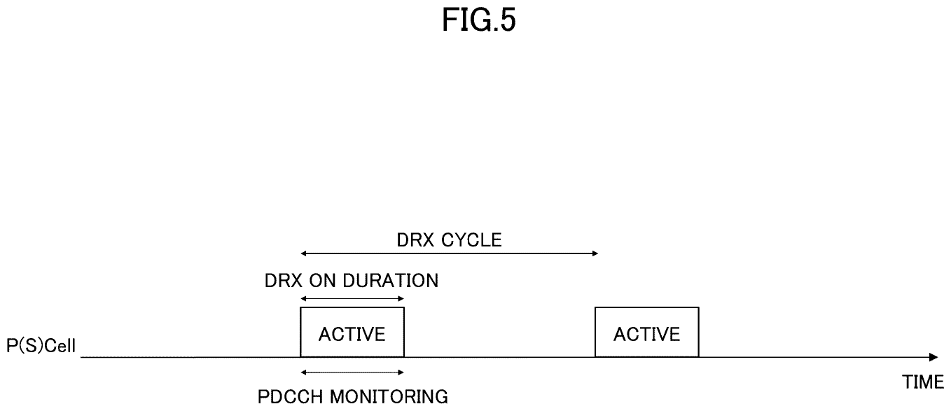

FIG. 4 is a sequence diagram for explaining an example of wireless power transfer according to an embodiment of the present invention. In step S101, the terminal 20 transmits, to the base station 10, a UE capability report regarding power transfer. In step S102, the base station 10 transmits, to the terminal 20, an indication that relates to power transfer. The indication about power transfer may be selected based on the UE capability report related to power transfer. In the following step S103, the terminal 20 carries out the power-receiving operation according to the function to reduce power consumption, and receives wireless power transfer from the power-transmitting device 30.

The function F to reduce power consumption may be, but is not limited to, any of the following:

Discontinuous reception (DRX); a wake-up signal (WUS); a low-power WUS; PDCCH skipping; search space (SS) set group switching; cross-slot scheduling; cross-carrier scheduling; periodic tracking reference signal (P-TRS)-based paging; and paging early indication (PEI)-based paging.

Note that, when paging is used, the terminal 20 in RRC_IDLE mode receives paging PDCCH/PDSCH regularly to check whether or not there is an update to the system information, whether or not there is emergency information such as one issued by the earthquake and tsunami warning system (ETWS), whether or not the terminal 20 is called, etc., and the network operator calls for the UE by using paging, so that DL signals can be transmitted.

The above operation makes it possible to reduce the UE's power consumption in communication, and supply power to the UE efficiently through power transfer.

FIG. 5 is a diagram for explaining an example (1) of reducing power consumption. As shown in FIG. 5, the UE monitors PDCCH during a period in which DRX function is “ON” (hereinafter “DRX-ON duration”). The DRX-ON duration may be repeated based on a DRX cycle.

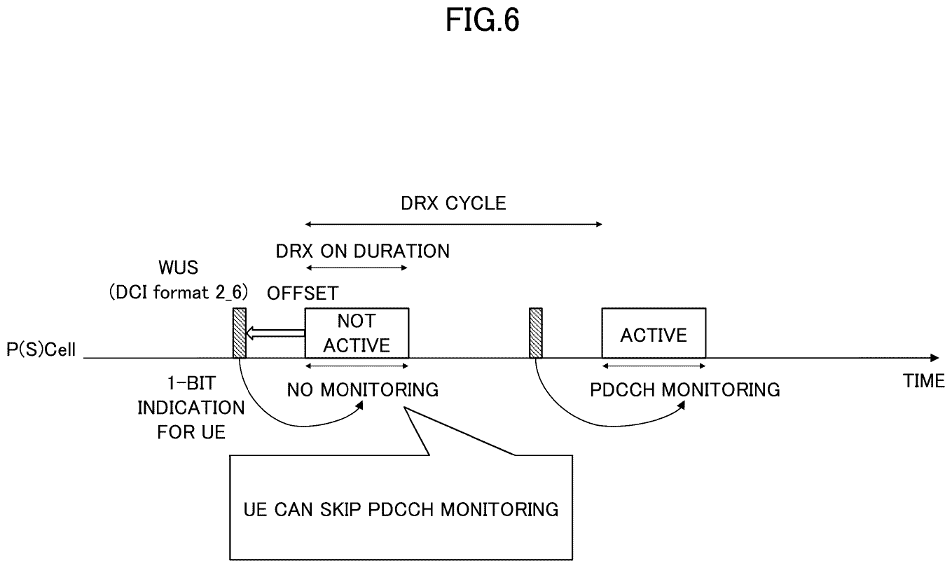

FIG. 6 is a diagram for explaining an example (2) of reducing power consumption. As shown in FIG. 6, by using a PDCCH-based WUS, whether or not to monitor PDCCH during the next DRX-ON duration can be indicated to one or more UEs. DCI format 2_6, in which the cyclic redundancy check (CRC) part is scrambled by PS-RNTI, is used as the PDCCH-based WUS. DCI format 2_6 in which the CRC part is scrambled by PS-RNTI may also be referred to as “DCI with CRC scrambled by PS-RNTI” (DCP). As shown in FIG. 6, considering the UE's processing time, a WUS monitoring occasion is set at an offset from the beginning of a DRX-ON duration. The gap created by this offset Can reduce the UE'S processing load and power consumption for the WUS. When the WUS indicates “not active” (i.e., there is no data transmission/reception), the UE can skip PDCCH monitoring during the next DRX-ON duration and immediately transition into sleep mode. For example, a default UE behavior for when a PDCCH-based WUS is not detected due to detection error, etc. may be configured. When the WUS indicates “active”, the UE may monitor PDCCH during the next DRX-ON duration.

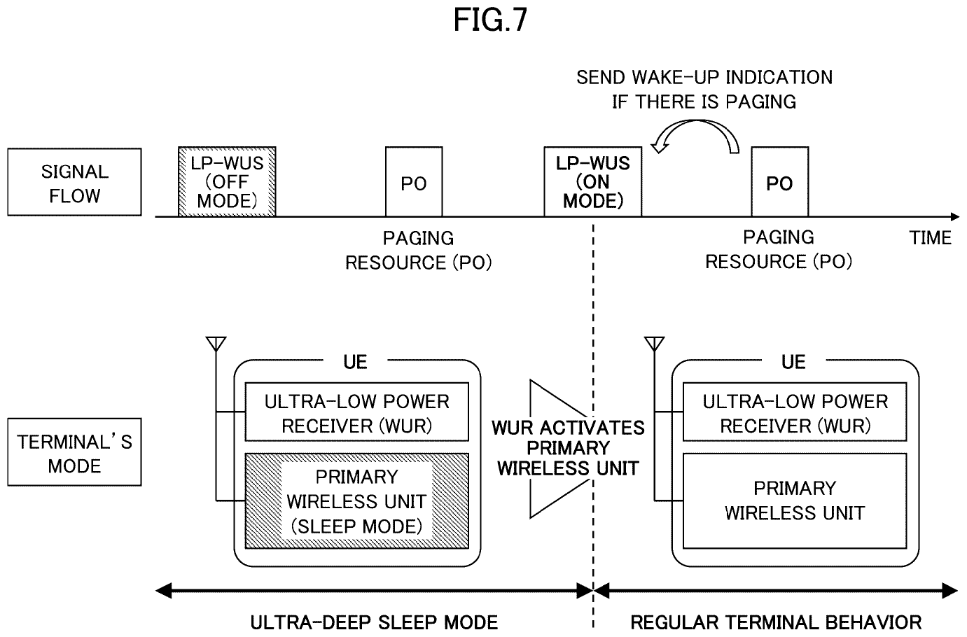

FIG. 7 is a diagram for explaining an example (3 ) of reducing power consumption. A dedicated receiver (a wake-up receiver or a “WUR”) with very low power consumption may be introduced to enable a drastic reduction in terminal power consumption. In the example of FIG. 7, the WUR, triggered by a low-power WUS (LP-WUS), wakes up the main wireless unit from sleep mode, and the main wireless unit, when in idle mode, is able to transition into sleep mode (ultra-deep sleep), so that a significant improvement in terminal power consumption is expected. If paging is available, a pre-wake-up indication is issued using an LP-WUS. A. signal for use only as an LP-WUS may be defined and used.

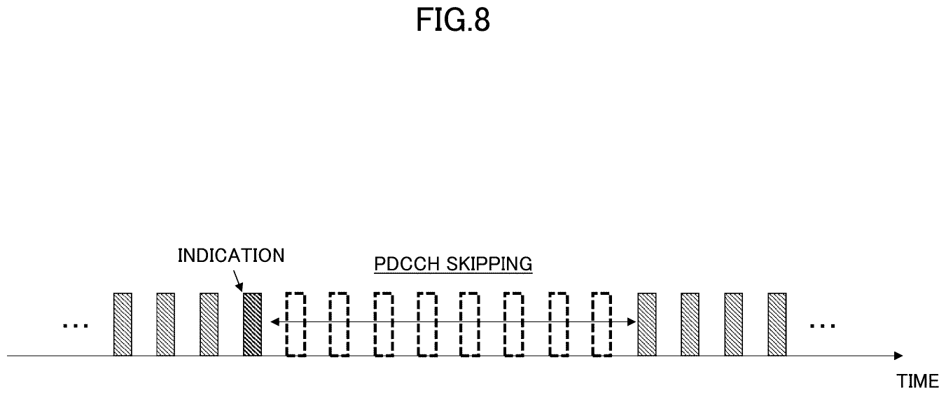

FIG. 8 is a diagram for explaining an example (4) of reducing power consumption. As shown in FIG. 8, the UE may carry out PDCCH skipping based on an indication. During PDCCH skipping, the UE does not monitor PDCCH.

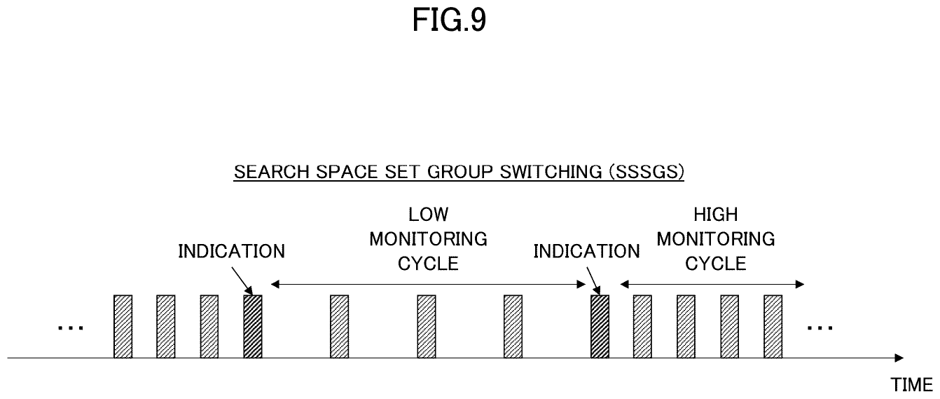

FIG. 9 is a diagram for explaining an example (5) of reducing power consumption. As shown in FIG. 9, the UE may carry out search space set group switching (SS set group switching) based on an indication. SS set group switching allows, for example, switching between a low monitoring cycle and a high monitoring cycle. By transitioning into a low monitoring cycle, the UE's power consumption can be reduced.

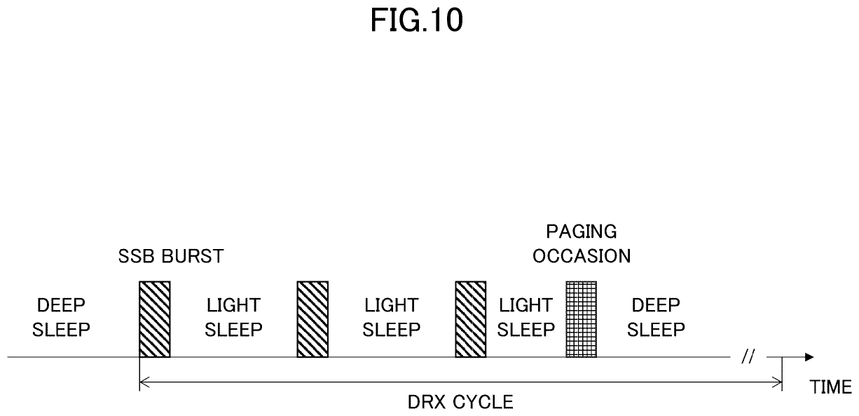

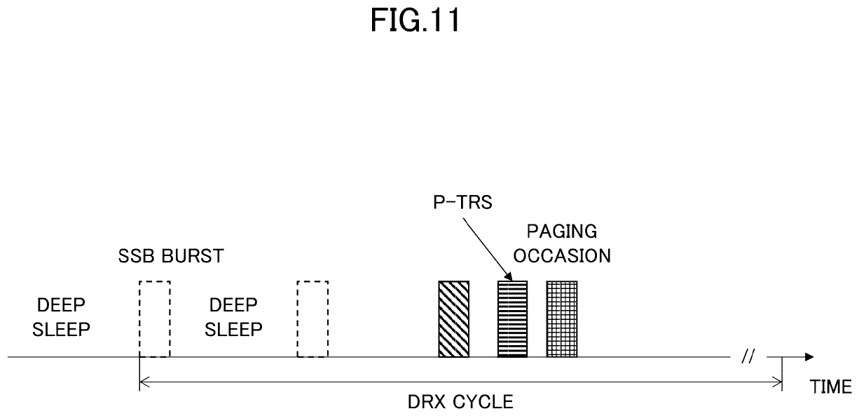

FIG. 10 is a diagram for explaining an example (6) of reducing power consumption. FIG. 11 is a diagram for explaining an example (7) of reducing power consumption. The base station 10 may indicate, to the UE, whether or not a periodic tracking reference signal (P-TRS) is available. The UE uses P-TRS while in connected mode, idle mode, and non-active mode, to carry out time and frequency tracking and auto gain control (AGC).

FIG. 10 shows an example case in which no P-TRS is configured. The UE wakes up from deep sleep to receive SSB bursts, goes into light sleep between SSB bursts, and monitors paging occasions.

FIG. 11 shows an example case in which a P-TRS is configured. Because the UE does not have to carry out time and frequency tracking and AGC according to the SSBs, the UE stays in deep sleep even after a DRX-ON duration begins, and carries out time and frequency tracking and AGC following a P-TRS transmitted shortly before a paging occasion.

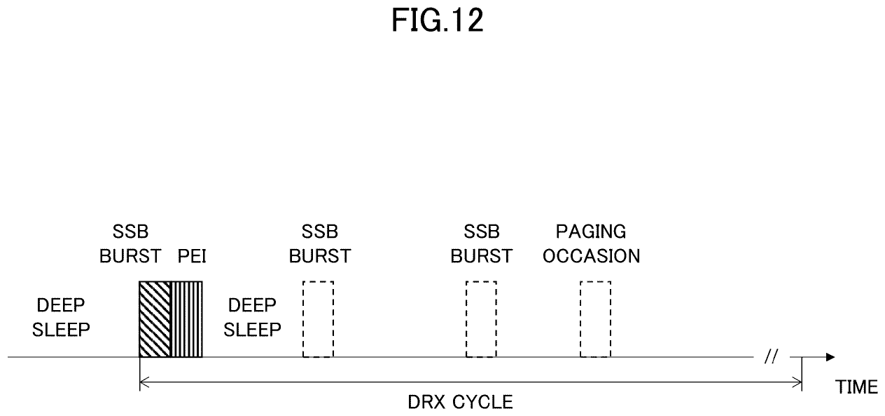

FIG. 12 is a diagram for explaining an example (8) of reducing power consumption. If a paging PDSCH does not carry a paging message, the power that the UE spends for the pre-wake-up operation prior to a paging occasion (PO) in a DRX cycle becomes a waste. Also, such an “unpaged” DRX cycle is estimated to occur at a very high rate. Therefore, as shown in FIG. 12, by introducing a paging early indication (PEI) and indicating whether or not the UE has to wake up upon a PO before the PO actually begins, it is possible to reduce the UE's power consumption.

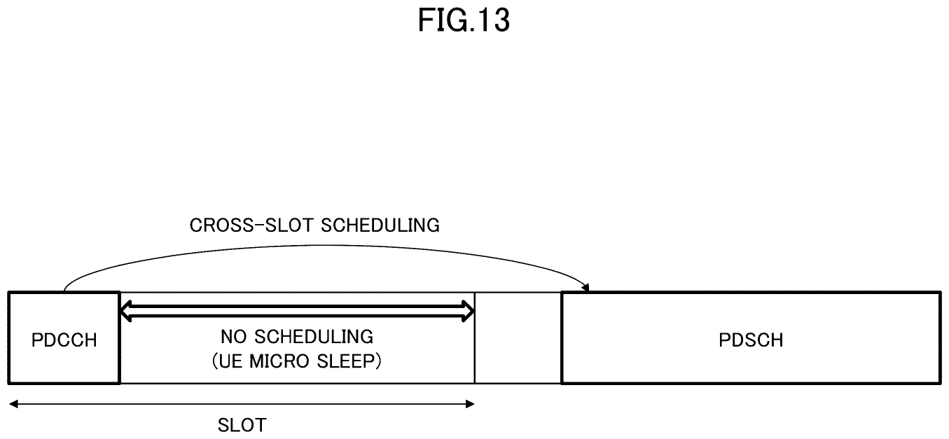

FIG. 13 is a diagram for explaining an example (9) of reducing power consumption. Introducing cross-slot scheduling as shown in FIG. 13 allows the UE to identify, in advance, a period in which no data is scheduled, and enter micro-sleep during that period. In other words, the RE unit and part of the hardware can be placed in power saving mode.

According to the power-saving function F, the UE may carry out the power-receiving operation during a time period X in which no signal reception takes place. Note that “signal reception” or saying that signals are received may be interchangeable with “signal reception and/or transmission” or saying that signals are received and/or transmitted.

The UE need not carry out the power-receiving operation during a time period Y in which signals are received.

The UE may carry out the power-receiving operation throughout the entire time period X or carry out the power-receiving operation for only part of the period. That is, during the time period X, except for part of the period, the power-receiving operation need not be carried out based on the UE's processing time. The power-receiving operation may be carried out only during a time period that is configured or indicated as a period for carrying out the power-receiving operation.

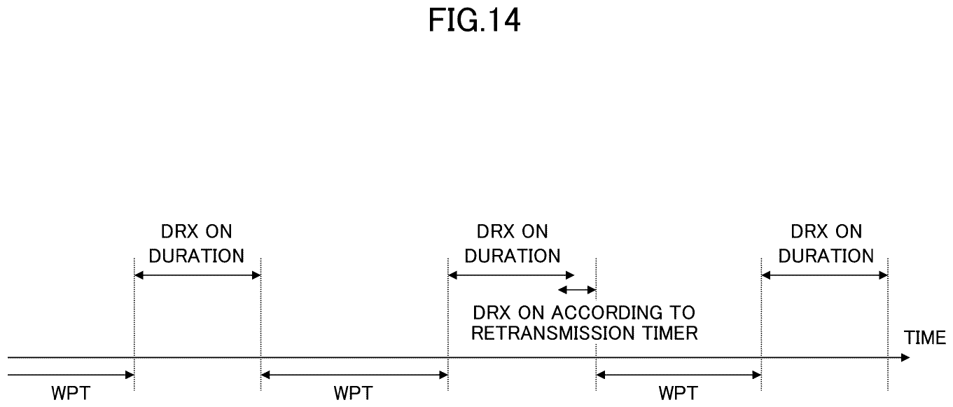

FIG. 14 is a diagram showing an example (1) of wireless power transfer according to an embodiment of the present invention. FIG. 14 shows an example case in which the function F is DRX. Referring to FIG. 14, the UE may carry out the power-receiving operation during a time period X in which DL signals (e.g., PDCCH, PDSCH, etc. are not received according to the DRX function, or may not carry out the power-receiving operation during DRX-ON durations or in a time period Y in which DL signals are received according to the DRX function.

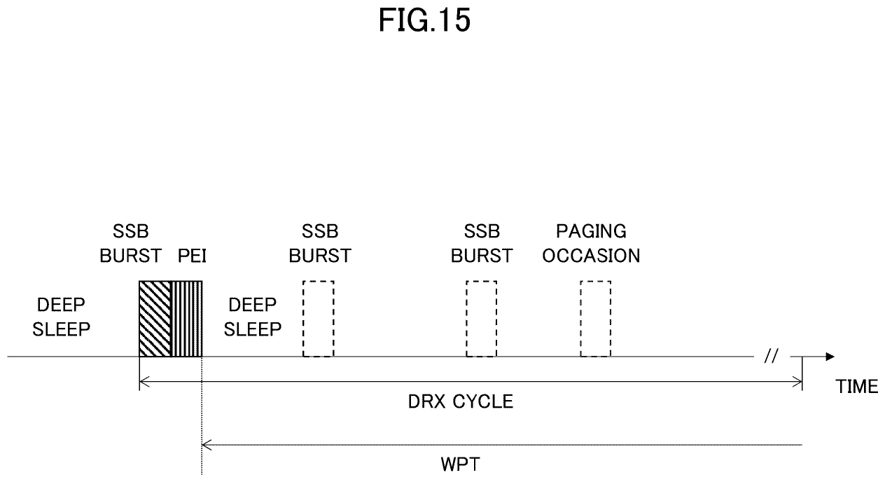

FIG. 15 is a diagram showing an example (2) of wireless power transfer according to an embodiment of the present invention. FIG. 15 shows an example case in which the function F is PEI-based paging. Assuming that the function F uses a WUS, an LP-WUS, P-TRS-based paging, or PEI-based paging, the UE may carry out the power-receiving operation during a time period in which DL signals are not received, according to the WUS, LP-WUS, P-TRS-based paging, or PEI-based paging (or in a time period X for which, for example, no indication to the effect that DL signals are going to be received is received, an indication to the effect that no DI signals are going to be received is received, etc.), may not carry out the power-receiving operation during a time period Y in which DL signals are received, according to the WUS, LP-WUS, P-TRS-based paging, or PEI-based paging (or in a time period Y for which, for example, an indication to the effect that DI signals are going to be received is received, no indication to the effect that DL signals are not going to be received is received, etc.).

The maximum value of the time gap T between the timing at which the WUS, LP-WUS, P-TRS-based paging, or PEI-based paging indication is received, and the timing at which the power-receiving operation begins, may be the same value as the maximum value of the time gap between the timing at which the above indication is received and the timing at which the DL signal corresponding to the indication is received when the UE does not carry out the power-receiving operation, or may be a larger value than when the UE does not carry out the power-receiving operation.

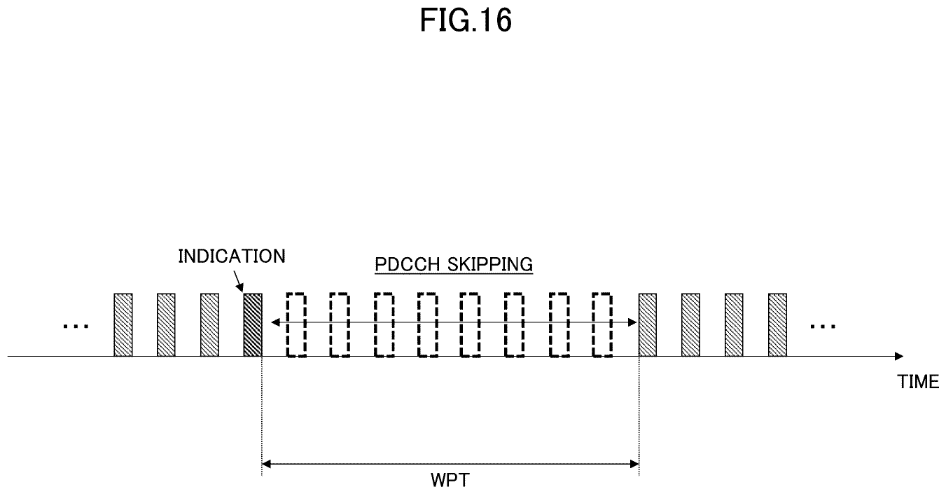

FIG. 16 is a diagram showing an example (3) of wireless power transfer according to an embodiment of the present invention. FIG. 16 shows an example case in which the function is PDCCH skipping. Referring to FIG. 16, the UE may carry out the power-receiving operation during a PDCCH skipping duration. The maximum value of the time gap T between the timing at which an indication of PDCCH skipping is received and the timing at which the power-receiving operation begins may be set to a specific value, may be the same value as the maximum value of the time gap between the timing at which the above indication is received and the timing at which the DL signal corresponding to the indication is received when the UE does not carry out the power-receiving operation, may be a larger value than when the UE does not carry out the power-receiving operation, or may be the same value as the maximum value of the time gap I between the timing at which a WUS, LP-WUS, P-TRS-based paging, or PEI-based paging indication is received, and the timing at which the power-receiving operation begins.

In the event the function F is SS set group switching, the UE may carry out the power-receiving operation if the PDCCH monitoring cycle is greater than or equal to a specific value. However, the UE need not carry out the power-receiving operation during a period in which DL signals are received. Also, the UE need not carry out the power-receiving operation if the PDCCH monitoring cycle is less than a specific value. The specific value may be defined or configured.

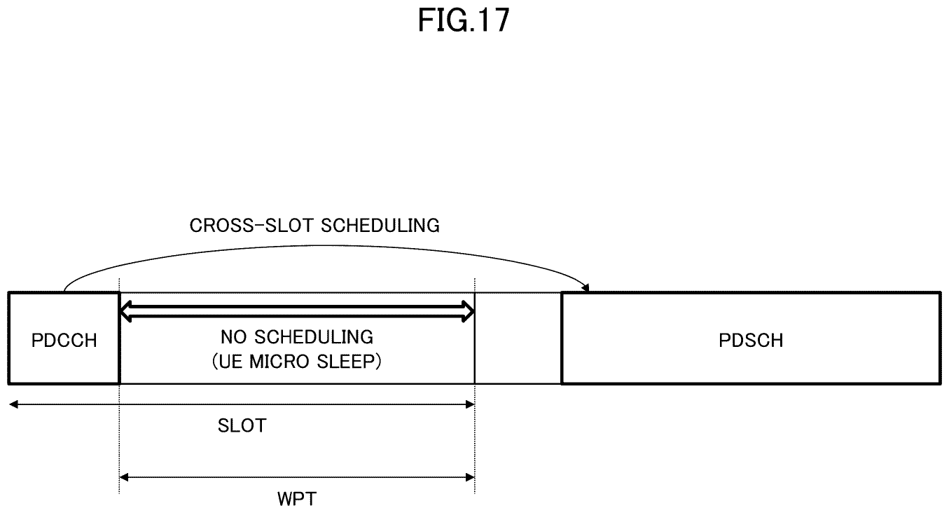

FIG. 17 is a diagram showing an example (4) of wireless power transfer according to an embodiment of the present invention. FIG. 17 shows an example case in which the function F is cross-slot scheduling. Referring to FIG. 17, according to the PDCCH-PDSCH offset and PDCCH monitoring occasion, the UE may carry out the power-receiving operation during a time period in which DL signals are not likely to be received, or may not carry out the power-receiving operation during a time period in which DL signals may be received.

The above-described UE operation of receiving power during a time period X in which the UE does not receive signals according to the function F to reduce power consumption may be applied only when the UE cannot communicate and receive a transfer of power at the same time, or its applicability may be determined based on an indication or configuration from the base station 10.

The above operation makes it possible to increase the UE's remaining battery power during a time period in which the UE reduces its power consumption. The power transfer operation can be optimized during non-receiving periods, which are determined and provided based on a variety of functions, so that decline in communication quality can be prevented.

Also, it may be assumed that the power-receiving operation is carried out only when the function F to reduce power consumption is configured. In the event the function F is not configured, wireless power transfer need not be carried out.

Also, all UEs with a capability to carry out the power-receiving operation may be capable of executing the function F to reduce their power consumption. A UE that reports to the network that it is capable of carrying out the power-receiving operation may also have to report to the network that it is capable of executing the function F to reduce its power consumption.

According to the above-described embodiment, the terminal 20 can appropriately carry out the power transfer operation based on a function to reduce power consumption.

In other words, it is possible to reduce terminal power consumption and carry out wireless power transfer in a wireless communication system.

### Device Structures

Next, example functional structures of the base station 10 and the terminal 20 having functions to implement the above-described processes and operations will be described. The base station 10 and the terminal 20 have functions to carry out the above-described embodiment. However, both the base station 10 and the terminal 20 may have only some of the functions of the embodiment.

### Base Station 10

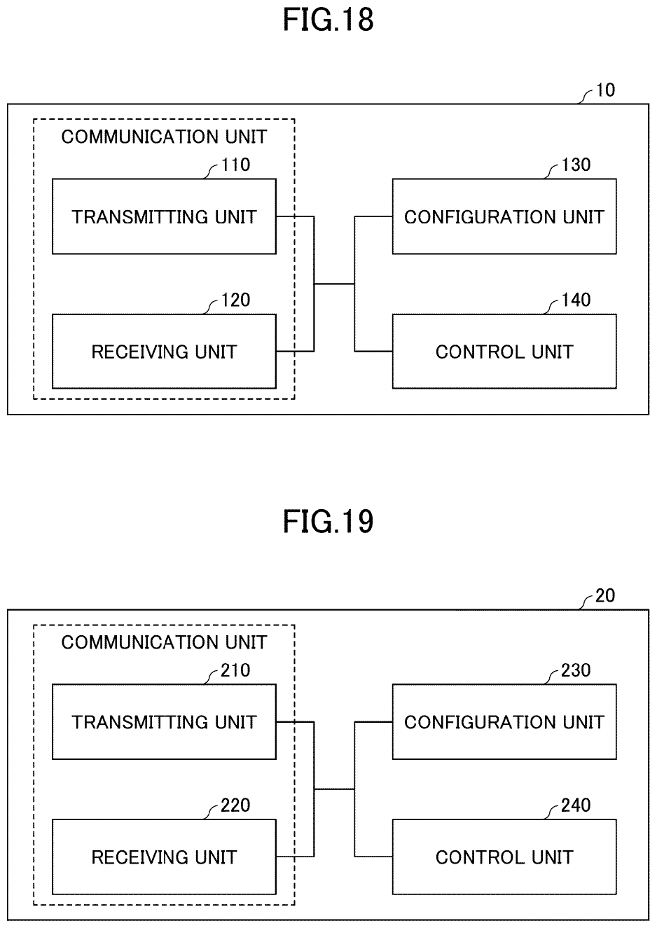

FIG. 18 is a diagram showing an example functional structure of. base station 10 according to an embodiment of the present invention. As shown in FIG. 18, the base station 10 has a transmitting unit 110, a receiving unit 120, a configuration unit 130, and a control unit 140. The functional structure shown in FIG. 18 is simply an example. As long as the operations according to the embodiment of the present invention can be implemented, any functional categories and any functional unit names may be used. The functional structure of the power-transmitting device 30 may be the same or substantially the same as that of the base station 10.

The transmitting unit 110 has, for example, a function to generate signals to be transmitted to the terminal 20 or other network nodes and transmit the signals via a wireless connection. The transmitting unit 110 also transmits inter-network node messages to other network nodes. The receiving unit 120 has, for example, a function to receive various signals transmitted from the terminal 20 and acquire, for example, higher layer information from the received signals. Also, the transmitting unit 110 has a function to transmit NR-PSS, NR-SSS, NR-PBCH, DL/UL control signals, etc., to the terminal 20. Also, the receiving unit 120 receives inter-network node messages from other network nodes.

The configuration unit 130 stores configuration information that is set in advance, as well as various configuration information to be transmitted to the terminal 20. The content of the configuration information include, for example, information about wireless power transfer.

The control unit 140 executes control to implement the functions described hereinabove with the embodiment. Also, the control unit 140 executes control related to wireless power transfer, as has been described with the embodiment. The functional unit related to signal transmission in the control unit 140 may be included in the transmitting unit 110, and the functional unit related to signal reception in the control unit 140 may be included in the receiving unit 120.

### Terminal 20

FIG. 19 is a diagram showing an example functional structure of a terminal 20 according to an embodiment of the present invention. As shown in FIG. 19, the terminal 20 has a transmitting unit 210, a receiving unit 220, a configuration unit 230, and a control unit 240. The functional structure shown in FIG. 19 is simply an example. As long as the operations according to the embodiment of the present invention can be implemented, any functional categories and any functional unit names may be used.

The transmitting unit 210 creates transmission signals from transmission data and transmits them via a wireless connection. The receiving unit 220 receives various signals via wireless connection, and obtains higher layer signals from the physical layer signals received. The receiving unit 220 also has a function to receive NR-PSS, NR-SSS, NR-PBCH, DL/UL/SL control signals, etc., transmitted from the base station 10. Furthermore, for example, in D2D communication, the transmitting unit 210 transmits a physical sidelink control channel (PSCCH), a physical sidelink shared channel (PSSCH), a physical sidelink discovery channel (PSDCH), a physical sidelink broadcast channel (PSBCH), etc., to other terminals 20, and the receiving unit 220 receives PSCCH, PSSCH, PSDCH, PSBCH, etc., from other terminals 20.

The configuration unit 230 stores various types of configuration information received from the base station 10 by the receiving unit 220 The configuration unit 230 also stores pre-configured configuration information. The content of the configuration information includes, for example, information related to wireless power transfer.

The control unit 240 executes control to implement the functions described hereinabove with the embodiment. Also, the control unit 240 executes control related to wireless power transfer as has been described with the embodiment. The functional unit related to signal transmission in the control unit 240 may be included in the transmitting unit 210, and the functional unit related to signal reception in the control unit 240 may be included in the receiving unit 220.

### Hardware Structures

The block diagrams (FIG. 18 and FIG. 19) used in the description of the above embodiment illustrate blocks of functional units. These functional blocks (components) are implemented by any combination of hardware and/or software. In addition, the method of implementing each functional block is not particularly limited. That is, each functional block may be implemented by using a single device that is physically or logically combined, or two or more devices that are physically or logically separated may be directly or indirectly connected (for example, by using a cable, radio, etc.), and each functional block may be implemented using these multiple devices. The functional blocks may be implemented by combining software with the device or devices.

The functions include, but are not limited to, judgment, determination, decision, calculation, computation, processing, derivation, research, search, verification, reception, transmission, output, access, resolution, selection, choosing, establishment, comparison, assumption, assumption, deeming, broadcasting, notifying, communicating, forwarding, configuring, reconfiguring, allocating, mapping, and assigning. For example, a functional block (component) that performs a transmission function is referred to as a “transmitting unit” or a “transmitter”. In either case, as described above, the method of implementation is not particularly limited.

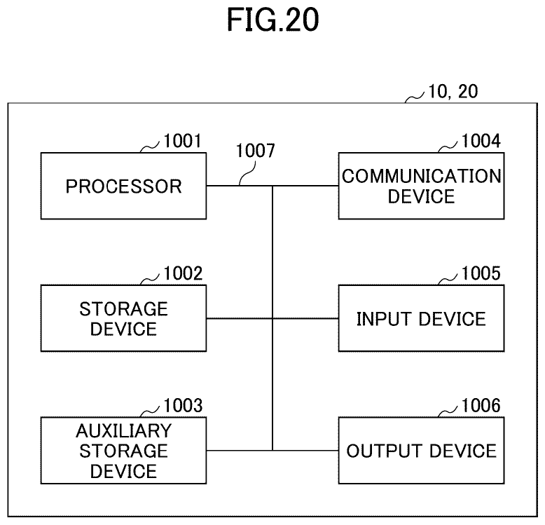

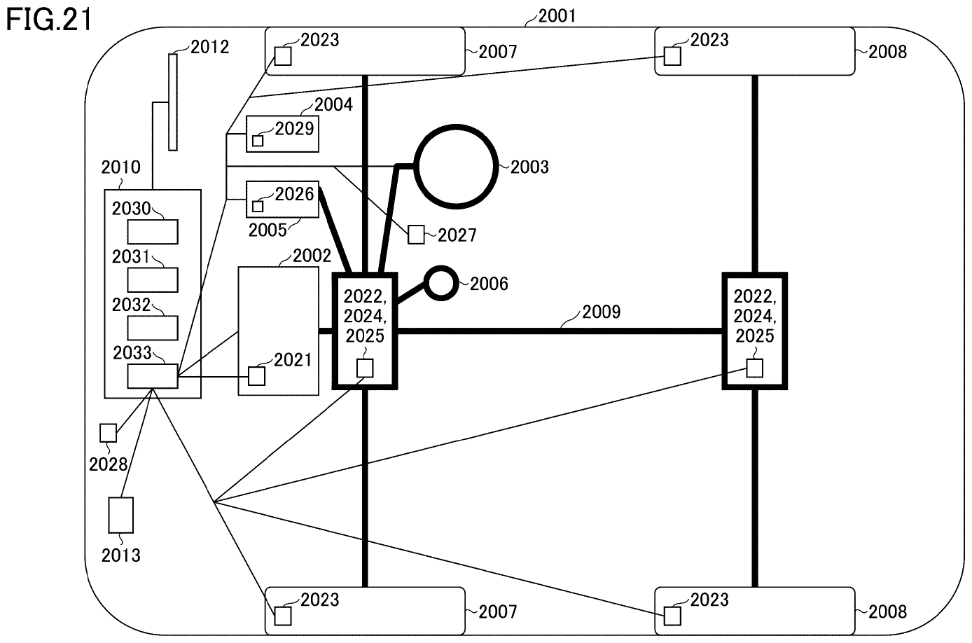

For example, the base station 10, the terminal 20, and so forth according to the embodiment of the present disclosure may function as a computer for processing the wireless communication method of the present disclosure. FIG. 20 is a diagram that illustrates an example hardware structure of the base station 10 and the terminal 20 according to the embodiment of the present disclosure. The network nodes may be structured the same or substantially the same as the base station 10. The USIM may be structured the same or substantially the same as the terminal 20. The base station 10 and the terminal 20 described above may be physically configured as a computer device including a processor 1001, a storage device 1002, an auxiliary storage device 1003, a communication device 1004, an input device 1005, an output device 1006, a bus 1007, and the like. The functional structure of the power-transmitting device 30 may be the same or substantially the same as that of the base station 10.

In the following description, the term “device” can be read as circuit, apparatus, unit, and So forth. The hardware structure of the base station 10 and the terminal 20 may be configured to include one or more of the devices illustrated in the drawings, or may be configured without some of the devices.

The functions of the base station 10 and the terminal 20 are realized by performing operations by the processor 1001 by reading predetermined software (programs) on hardware such as the processor 1001 and the storage device 1002, and controlling communication by the communication device 1004 and controlling at least one of reading and writing of data in the storage device 1002 and the auxiliary storage device 1003.

The processor 1001 operates, for example, an operating system to control the entire computer. The processor 1001 may be composed of a central processing unit (CPU) including an interface with peripheral devices, a control device, an arithmetic device, a register, and the like. For example, the above-described control unit 140, control unit 240, and the like may be implemented by the processor 1001.

The processor 1001 reads out programs (program codes), software modules, data, or the like from at least one of the auxiliary storage device 1003 and the communication device 1004 to the storage device 1002, and performs various processes in accordance with the above. As for the programs, programs that cause the computer to execute at least part of the operations described in the above embodiment may be used. For example, the control unit 140 of the base station 10 illustrated in FIG. 18 may be stored in the storage device 1002 and implemented by control programs that operate on the processor 1001. For example, the control unit 240 of the terminal 20 illustrated in FIG. 19 may be stored in the storage device 1002 and implemented by control programs that operate on the processor 1001. Although the foregoing processes have been described and executed by one processor 1001, they may be executed simultaneously or sequentially by two or more processors 1001. The processor 1001 may be implemented by one or more chips. The programs may be transmitted from the network via a telecommunication line.

The storage device 1002 is a computer-readable recording medium and may be composed of at least one of, for example, a read-only memory (ROM), an erasable programmable ROM (EPROM), an electrically erasable programmable ROM (EEPROM), a random access memory (RAM), and the like. The storage device 1002 may be referred to as a register, cache, main memory (main storage device), or the like. The storage device 1002 can store programs (program codes), software modules, and so forth, executable to implement the communication method according to the embodiment of the present disclosure.

The auxiliary storage device 1003 is a computer-readable recording medium and may be composed of at least one of an optical disk, such as a compact disc ROM (CD-ROM), a hard disk drive, a flexible disk, a magneto-optical disk (for example, a compact disc, a digital versatile disc, a Blu-ray disc (registered trademark), etc.), a smart card, a flash memory (for example, a card, stick, a key drive), a floppy disk (registered trademark), a magnetic strip, and the like. The storage medium described above may be, for example, a database, a server, or other suitable medium that includes at least one of a storage device 1002 and an auxiliary storage device 1003.

The communication device 1004 is hardware (a transceiving device) for performing communication between computers via at least one of a wired network and a wireless network, and is also referred to as a “network device”, a “network controller”, a “network card”, a “communication module”, or the like. The communication device 1004 may be composed of a high frequency switch, a duplexer, a filter, a frequency synthesizer, or the like, for example, to implement at least one of frequency division duplex (FDD) and time division duplex (TDD). For example, the transmitting/receiving antenna, the amplifier unit, the transceiving unit, the transmission line interface, and the like may be implemented by the communication device 1004. The transceiving unit may be physically or logically isolated, respective implementations of a transmitting unit and a receiving unit.

The input device 1005 is an input device (for example, a keyboard, a mouse, a microphone, a switch, a button, a sensor, etc.) that accepts external input. The output device 1006 is an output device (for example, display, a speaker, an LED lamp, etc.) that implements external output. The input device 1005 and the output device 1006 may have an integral structure (for example, a touch panel).

Each device, such as the processor 1001 and the storage device 1002, is connected by a bus 1007 for communicating information. The bus 1007 may be constructed using a single bus or may be constructed using different buses between devices.

The base station 10 and the terminal 20 may also include hardware such as a microprocessor, a digital signal processor (DSP), an application-specific integrated circuit (ASIC), a programmable logic device (PLD), a field programmable gate array (FPGA), and so forth, and some or all of the functional blocks may be implemented by the hardware. For example, the processor 1001 may be implemented by using at least one of these hardware components.

The power-transmitting device 30 may have a piece of hardware that constitutes a power transmitting unit for transferring power to the terminal 20 via wireless means The terminal 20 may have a piece of hardware that constitutes a power receiving unit for receiving power transferred from the power-transmitting device 30 via wireless means. Furthermore, the terminal 20 may have a piece of hardware that constitutes a power transmitting unit for transferring power to another terminal 20 via wireless means.

FIG. 21 shows an example structure of a vehicle 2001. As shown in FIG. 21, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. The embodiment and examples described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the sensors 2021 to 2029 provided in the vehicle 2001. The electronic control unit 2010 may be referred to as an “electronic control unit” (ECU).

The signals from the sensors 2021 to 2029 include a current signal from a current sensor 2021 that senses the current of the motor, a front or rear wheel rotation speed signal acquired by a rotation speed sensor 2022, a front or rear wheel air pressure signal acquired by an air pressure sensor 2023, a vehicle speed signal acquired by a vehicle speed sensor 2024, an acceleration signal acquired by an acceleration sensor 2025 stepped-on accelerator pedal signal acquired by an accelerator pedal sensor 2029, a stepped-on brake pedal signal acquired by a brake pedal sensor 2026, a shift lever operation signal acquired by a shift lever sensor 2027, and a detection signal, acquired by an object detection sensor 2028, for detecting an obstacle, a vehicle, a pedestrian, and the like.

The information service unit 2012 includes various devices for providing various information such as driving information, traffic information, and entertainment information, including a car navigation system, an audio system, a speaker, a television, and a radio, and one or more ECUs that control these devices. The information service unit 2012 provides various multimedia information and multimedia services to the occupants of the vehicle 2001 by using information obtained from external devices through the communication module 2013 or the like. The information service unit 2012 may include an input device (for example, a keyboard, a mouse, a microphone, a switch, a button, a sensor, a touch panel, etc.) that accepts external inputs, and may also include an output device (for example, a display, a speaker, an LED lamp, a touch panel, etc.) that executes external outputs.

A driver assistance system unit 2030 includes: various devices for providing functions of preventing accidents and reducing the driver's burden of driving, such as a millimeter wave radar, a light detection and ranging (LiDAR) system, a camera, positioning locator (for example, GNSS), map information (for example, high definition (HD) map, autonomous vehicle (AV) map, etc.), a gyro system (for example, an inertial measurement unit (IMU) an inertial navigation system (INS), etc.), an artificial intelligence (AI) chip, and an AI processor; and one or more ECUs that control these devices. In addition, the driver assistance system unit 2030 transmits and receives various information via the communication module 2013 to implement a driver assistance function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031, the memory (ROM, RAM) 2032 in the electronic control unit 2010, and the sensors 2021 to 29 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through wireless communication. The communication module 2013 may be internal or external to the electronic control unit 2010. The external devices may include, for example, a base station, a mobile station, or the like.

The communication module 2013 may transmit at least one of: signals input to the electronic control unit 2010 from the sensors 2021 to 2029; information obtained based on these signals; and information based on inputs from the outside (user) obtained via the information service unit 2012, to external devices via wireless communication. The electronic control unit 2010, the sensors 2021 to 2029, the information service unit 2012, and the like may be referred to as an “input unit” that accepts inputs. For example, PUSCH transmitted by the communication module 2013 may include information that is based on an input such as one described above.

The communication module 2013 receives various information (traffic information, signal information, inter-vehicle distance information, etc.) transmitted from external devices and displays these pieces of information on an information service unit 2012 provided in the vehicle 2001. The information service unit 2012 may also be referred to as an “output unit” that outputs information (or that, for example, outputs information to devices such as a display or a speaker based on PDSCH (or data/information decoded from PDSCH) received by the communication module 2013). In addition, the communication module 2013 stores the information received from the external devices in the memory 2032, to which the microprocessor 2031 has access. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, and so forth, mounted in the vehicle 2001.

### Summary of Embodiment

As described above, according to an embodiment of the present invention, a terminal is provided. This terminal includes: a communication unit configured to receive, from a base station, an indication related to power transfer; a power receiving unit configured to receive wireless power transfer, according to the indication related to power transfer; and a control unit configured to determine, according to a function to reduce power consumption, whether or not to carry out an operation related to power transfer.

Structured as described above, the terminal 20 can appropriately carry out the power transfer operation according to the function to reduce power consumption. In other words, it is possible to carry out wireless power transfer by reducing terminal power consumption in a wireless communication system.

The control unit may cause a power-receiving operation during a time period in which signals are not transmitted or received, according to the function to reduce power consumption. Structured thus, the terminal 20 can appropriately carry out the power transfer operation according to the function to reduce power consumption.

The control unit need not cause a power-receiving operation during a time period in which signals are transmitted and received, according to the function to reduce power consumption. Structured thus, the terminal 20 can appropriately carry out the power transfer operation according to the function to reduce power consumption.

The control unit may determine, only when simultaneous communication and power transfer is not feasible, whether or not to carry out the operation related to power transfer, according to a function to reduce power consumption. Structured thus, the terminal 20 can appropriately carry out the power transfer operation according to the function to reduce power consumption.

The function to reduce power consumption may use one of: discontinuous reception (DRX); a wake-up signal (WUS); a low-power WUS; physical downlink control channel (PDCCH) skipping; search space (SS) set group switching; cross-slot scheduling; cross-carrier scheduling; periodic tracking reference signal (P-TRS)-based paging; and paging early indication (PEI)-based paging. Structured thus, the terminal 20 can appropriately carry out the power transfer operation according to the function to reduce power consumption.

Furthermore, according to an embodiment of the present invention, a power transfer method to be carried out by a terminal is provided. This method includes: a step of receiving, from a base station, an indication related to power transfer; a step of receiving wireless power transfer, according to the indication related to power transfer; and a step of determining, according to a function to reduce power consumption, whether or not to carry out an operation related to power transfer.

Structured thus, the terminal 20 can appropriately carry out the power transfer operation according to the function to reduce power consumption. In other words, it is possible to carry out wireless power transfer by reducing terminal power consumption in a wireless communication system.

### Notes on Embodiment

An example embodiment of the present invention has been described above, but the disclosed invention is not limited to the above embodiment, and those skilled in the art would understand that there may be various modified examples, revised examples, alternative examples, substitution examples, and the like In order to facilitate understanding of the invention, specific numerical values have been used for description, but the numerical values are merely examples, and any suitable values may be used unless otherwise specified. The classification of items in the above description is not essential to the present invention. Matters described as two or more items may be combined if necessary, and a matter described as one item may be applied to another item (as long as there is no contradiction). The boundary between functional units or processing units in a functional block diagram does not necessarily correspond to the boundary between physical parts. Operations of multiple functional units may be performed physically by one component, or an operation of one functional unit may be physically performed by multiple parts. In the processing procedures described in the embodiment, the order of the processes may be changed as long as there is no contradiction. For the sake of convenience of processing description, the base station 10 and the terminal 20 are described using functional block diagrams, but such devices may be implemented by hardware, software, or combination of these. Software executed by the processor included in the base station 10 according to the embodiment of the present invention and software executed by the processor included in the terminal 20 according to the embodiment of the present invention may be stored in a random access memory (RAM), a flash memory, a read-only memory (ROM), an EPROM, an EEPROM, a register, an hard disk drive (HDD), a removable disk, a CD-ROM, a database, a server, or any other appropriate storage medium.

Furthermore, indication of information is not limited to the embodiment or examples described in the present disclosure, and may be provided by using any other method. For example, the indication of information may be provided by physical layer signaling (for example, downlink control information (DCI) or uplink control information (UCI)), higher layer signaling (for example, radio resource control (RRC) signaling, medium access control (MAC) signaling, broadcast information (master information block (MIB), system information block (SIB), etc.), other signals, or a combination thereof. Furthermore, RRC signaling may be referred to as an “RRC message” and may be, for example, an RRC connection Setup message, an RRC connection reconfiguration message, or the like.

Each embodiment and example described in the present disclosure may be applied to at least one of long-term evolution (LTE), LTE-advanced (LTE-A), SUPER 3G, IMT-Advanced, 4th generation mobile communication system (4G), 5th generation mobile communication system (5G), 6th generation mobile communication system (6G), x-th generation mobile communication system (xG) (where “x” is an integer, decimal, etc.), future radio access (FRA), new radio (NR), new radio access (NX), future generation radio access, W-CDMA (registered trademark), GSM (registered trademark), CDMA 2000, ultra-mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and next generation systems enhanced, modified, created, and defined based on these standards. Furthermore, multiple systems (for example, a combination of at least one of LTE and LTE-A, with 5G) may be combined to be applied.

The order of the processing procedures, the order of the sequences, the order of the flowcharts, and the like of the embodiment and examples described in this specification may be changed, provided that there is no contradiction. For example, the method described in the present disclosure presents elements of various steps with an example order and is not limited to the presented, specific order.

In this specification, a specific operation to be performed by the base station 10 may be performed by its upper node in some cases. In a network including one or more network nodes including the base station 10, various operations performed for communication with the terminal 20 can be obviously performed by at least one of the base station 10 and any network node (for example, an MME, an S-GW, and so forth, but these are by no means limiting) other than the base station 10. Cases have been shown above in which there is one network node other than the base station 10. The one network node may be a combination of multiple other network nodes (for example, MME and S-GW).

Information, a signal, or the like described in the present disclosure may be output from a higher layer to a lower layer (or from a lower layer to a higher layer). Information, a signal, or the like described in the present disclosure may be input and output via multiple network nodes.

Input and output information and the like may be stored in a specific place (for example, a memory), or may be managed by using a management table. Input and output information and the like may be overwritten, updated, or additionally written. Output information and the like may be deleted. Input information and the like may be transmitted to other devices.

The determination in the present disclosure may be made in accordance with a value (0 or 1) represented by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, software application, software package, a routine, a subroutine, an object, an executable file, an execution thread, a procedure, function, and the like, regardless of. whether software is called “software”, “firmware”, “middleware”, a “microcode”, a “hardware description language”, or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of these wired technology and radio technology is included in a definition of a transmission medium.

Information, signals, and the like described in the present disclosure may be expressed using any one of a variety of techniques. For example, data, instructions, commands, information, signals, bits, symbols, chips, and the like, which are mentioned throughout the above description, may be expressed by voltages, currents, electromagnetic waves magnetic fields or magnetic particles, optical fields or photons, or any combination thereof.

The terms described in the present disclosure and the terms necessary for understanding the present disclosure may be replaced with terms having the same or similar meanings. For example, at least one of a channel and a symbol may be a signal (signaling). Furthermore, a signal may be a message. Furthermore, a component carrier (CC) may be referred as a “carrier frequency”, a “cell”, a “frequency carrier”, or the like.

The terms “system” and “network” used in the present disclosure are interchangeable.

Furthermore, the information, parameters, and the like described in the present disclosure may be expressed by using absolute values, may be expressed by using relative values from predetermined values, or may be expressed by using any other corresponding information. For example, radio resources may be indicated by indices.

The names used for the above-described parameters are not limited names in any point of view. Furthermore, mathematical formulas or the like using the parameters may be different from those explicitly disclosed in the present disclosure. Since various channels (for example, PUCCH, PDCCH, etc.) and information elements can be identified by any suitable names, various names assigned to the various channels and the information elements are not limited names in any point of view.

In the present disclosure, the terms “base station (BS)”, “radio base station”, “base station device”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to by a term such as a “macrocell”, a “small cell”, a “femtocell”, and a “picocell”.

The base station can accommodate one or more (for example, three) cells. In a case in which the base station accommodates multiple cells, the entire coverage area of the base station can be partitioned into a plurality of small areas, and each small area can provide a communication service through a base station subsystem (for example, a small indoor base station (RRH: Remote Radio Head)). The term “cell” or “sector” refers to the whole or a part of the coverage area of at least one of the base station and the base station subsystem that performs a communication service in the coverage.

In the present disclosure, when a base station transmits information to a terminal, this may be interpreted as meaning that the base station controls or sends a command to the terminal based on the information.

In the present disclosure, the terms “mobile station (MS)”, “user terminal”, “user equipment (UE)”, “terminal”, and the like can be used interchangeably.

The mobile station may be referred to, by a person ordinarily skilled in the art, as a “subscriber station”, “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms.

At least one of the base station and the mobile station may be also referred to as “transmission device”, a “receiving device”, a “communication device”, or the like. At least one of the base station and the mobile station may be a device installed in a mobile body, a mobile body itself, or the like. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be replaced by the user terminal. For example, various embodiments and examples of the present disclosure may be applied to a configuration in which communication between the base station and the user terminal is replaced by communication between multiple terminals 20 (such communication may be referred to as “device-to-device (D2D)” communication, “vehicle-to-everything (V2X)” communication, etc.). In this case, the terminals 20 may have and perform the functions that the base station 10 described above has. The phrases “uplink” and “downlink” may also be replaced by phrases corresponding to terminal-to-terminal communication (for example, “side”). For example, an uplink channel, a downlink channel, or the like may be replaced by a side channel.

Similarly, the user terminal in the present disclosure may be replaced with the base station. In this case, the base station may have the functions of the above-described user terminal.

The terms “determination (determining)” and “decision (determining) ” used in the present specification may include various types of operations. The “determination” and “decision” may include deeming “judging”, “calculating”, “computing”, “processing”, “deriving”, “investigating”, “looking up (for example, searching in a table, database, or another data structure)”, “searching”, “inquiring”, or “ascertaining” as “determining” and/or “deciding”. Furthermore, the “determination” and “decision” may include deeming “receiving (for example, receiving information) ”, “transmitting (for example, transmitting information)”, “inputting”, “outputting”, or “accessing (for example, accessing data in a memory)” as “determining” and/or “deciding”. Furthermore, the “determination” and “decision” may include deeming “resolving”, “selecting”, “choosing”, “establishing”, or “comparing” as “determining” and/or “deciding”. Namely, the “determination” and “decision” may include deeming an operation as “determining” and/or “deciding”. Furthermore, “determining” may be replaced with “assuming”, “expecting”, “considering”, or the like.

The terms “connected”, “coupled”, or variations thereof may mean any direct or indirect connection or coupling between two or more elements and may include the presence of one or more intermediate elements between two elements which are “connected” or “coupled”. The coupling or the connection between the elements may be physical, logical, or a combination thereof. For example, “connection” may be replaced with “access”. In the present disclosure, two elements may be considered to be “connected” or “coupled” with each other using at least one of one or more electric wires, cables and/or a printed electrical connection or using electromagnetic energy having a wavelength in a radio frequency region, a microwave region, or a light (both visible and non-visible) region as non-limiting and non-exhaustive examples.

A reference signal may be abbreviated as “RS” and may be referred to as a “pilot”, depending on the standard that is applied.

The phrase “based on” used in the present disclosure does not only mean “based only on”, unless otherwise stated. In other words, the phrase “based on” means both “based only on” and “based at least on”.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

Furthermore, “means” in the structure of each of the above devices may be replaced with “unit”, “part”, “circuit”, “device”, or the like.

In the case where the terms “include”, “including” and variations thereof are used in the present disclosure, these terms are intended to be comprehensive in the same way as the term “comprising”. Further, the term used “or” in the present specification is not intended to be an “exclusive or”.

A radio frame may include one or more frames in the time domain. In the time domain, each of one or more frames may be referred to as a “subframe”. The subframe may further include one or more slots in the time domain. The subframe may have a fixed time length (for example, 1 ms) not depending on numerology.

Numerology may be a communication parameter applied to at least one of transmission and reception of a certain signal or channel. For example, numerology may indicate at least one of subcarrier spacing (SCS), the bandwidth, the symbol length, the cyclic prefix length, the transmission time interval (TTI), the number of symbols per TTI, the radio frame structure, a specific filtering process performed in the frequency domain by a transceiver, a specific windowing process performed in the time domain by a transceiver, and the like.

A slot may include one or more symbols (orthogonal frequency division multiplexing (OFDM) symbols, single carrier frequency division multiple access (SC-FDMA) symbols, etc.) in the time domain. A slot may be a time unit based on numerology.

A slot may include a plurality of mini slots. Each mini slot may include one or more symbols in the time domain. Furthermore, a mini slot may be referred to as a “sub-slot”. A mini slot may include fewer symbols than a slot. PDSCH (or PUSCH) that is transmitted in a unit of time greater than a mini slot may be referred to as “PDSCH (or PUSCH) mapping type A”. PDSCH (or PUSCH) that is transmitted using a mini slot may be referred to as “PDSCH (or PUSCH) mapping type B”.

Any one of a radio frame, a subframe, a slot, mini slot, and a symbol indicates a time unit for transmitting a signal. As a radio frame, a subframe, a slot, a mini slot, and a symbol, different name corresponding to them may be used.

For example, one subframe may be referred to as a “transmission time interval (TTI)”, or a plurality of consecutive subframes may be referred to as a “TTI”, or one slot or one mini slot may be referred to as a “TTI”. In other words, at least one of the subframe and the TTI may be a subframe (1 ms) in conventional LTE, may be a period shorter than 1 ms (for example, 1 to 13 symbols), or may be a period longer than ms. A unit representing the TTI may be referred to as a “slot”, “mini slot”, or the like, instead of “subframe”.

Here, for example, the TTI refers to a minimum time unit of scheduling in Wireless communication. For example, in an LTE system, the base station performs scheduling of allocating radio resources (frequency bandwidth, transmission power, or the like which can be used in each terminal 20) to each terminal 20 in units of TTIs. The definition of the TTI is not limited thereto.

The TTI may be a transmission time unit such as a channel-coded data packet (transport block), a code block, or a codeword, or may be a processing unit of, for example, scheduling or link adaptation. Furthermore, when a TTI is provided, the time interval (for example, the number of symbols) in which a transport block, a code block, a codeword, or the like is actually mapped may be shorter than the TTI.

When one slot or one mini slot is referred to as a “TTI”, one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a “common TTI” (TTI in LTE Rel. 8 to 12), a “normal TTI”, a “long TTI”, a “common subframe”. a “normal subframe”, a “long subframe”, a “slot”, or the like. A TTI shorter than a common TTI may be referred to as a “reduced TTI”, a “short TTI”, a “partial TTI” (a partial or fractional TTI), a “reduced subframe”, a “short subframe”, a “mini slot”, a “sub slot”, a “slot”, or the like.

Furthermore, a long TTI (for example, a normal TTI, a subframe, etc.) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain, and may include one or more consecutive subcarriers in the frequency domain. The number of subcarriers included in an RB may be the same, irrespective of the numerology and may be, for example, 12. The number of subcarriers included in an RB may be determined based on numerology.

An RB may include a plurality of symbols in the time domain, and may be one slot, one mini-slot, one subframe, or one TTI in length. One TTI, one subframe, and so on each may be constituted of one or a plurality of resource blocks.

Furthermore, one or more RBs may be referred to as a “physical resource block (PRB) ”, a “subcarrier group (SCG)”, a “resource element group (REG)”, a “PRB pair”, an “RB pair”, or the like.

Furthermore, a resource block may be formed with one or more resource elements (REs). For example, one RE may be a radio resource field of one subcarrier and one symbol.

A bandwidth part (BWP) (which may be referred to as a “partial bandwidth” or the like) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include BWP for UL (UL BWP) and BWP for DL (DL BWP). In the terminal 20, one or more BWPs may be configured in one carrier.

At least one of configured BWPs may be active, and UE need not assume that predetermined signals/channels are transmitted and received outside an active BWP. Furthermore, a “cell”, a “carrier”, or the like in the present disclosure may be replaced with a “BWP”.

Structures of the radio frame, the subframe, the slot, the mini slot, and the symbol are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the cyclic prefix (CP) length, and the like can be variously changed.

In the present disclosure, for example, when an article such as “a”, “an”, or “the” in English is added by a translation, the present disclosure may include a case in which a noun following the article is the plural.

In the present disclosure, “A and B are different” may mean “A and B are different from each other”. However, this may also mean “A and B are different from C”. Terms such as “separated” or “combined” may be interpreted as well as “different”.

Each embodiment or example described in the present disclosure may be used alone, in combination, or may be switched in accordance with the implementation. Furthermore, indication of predetermined information (for example, indication of “being X”) is not limited to indication performed explicitly, but may be performed implicitly (for example, not notifying the predetermined information).

Although the present disclosure has been described above in detail, it is obvious to those skilled in the art that the present disclosure is not limited to the embodiment described in the present disclosure. The present disclosure may be implemented as revised and modified embodiments without departing from the gist and scope of the present disclosure as set forth in the accompanying claims. Accordingly, the description of the present disclosure is for the purpose of illustration and does not have any restrictive meaning to the present disclosure.

### DESCRIPTION OF THE REFERENCE NUMERALS

10 base station
110 transmitting unit
120 receiving unit
130 configuration unit
140 control unit
20 terminal
210 transmitting unit
220 receiving unit
230 configuration unit
240 control unit
30 power-transmitting device
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 rotation speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port (IO port)

1. A terminal comprising:
a communication unit configured to receive, from base station, an indication related to power transfer;
power receiving unit configured to receive wireless power transfer, according to the indication related to power transfer; and
a control unit configured to determine, according to a function to reduce power consumption, whether or not to carry out an operation related to power transfer.

2. The terminal according to claim 1, wherein the control unit causes a power-receiving operation during a time period in which signals are not transmitted or received, according to the function to reduce power consumption.

3. The terminal according to claim 1, wherein the control unit does not cause a power-receiving operation during a time period in which signals are transmitted and received, according to the function to reduce power consumption.

4. The terminal according to claim 1, wherein, only when simultaneous communication and power transfer is not feasible, the control unit determines whether or not to carry out the operation related to power transfer, according to the function to reduce power consumption.

5. The terminal according to claim 1, wherein the function to reduce power consumption uses one of:
discontinuous reception (DRX);
a wake-up signal (WUS);
a low-power WUS;
physical downlink control channel (PDCCH) skipping;
search space (SS) set group switching;
cross-slot scheduling;
cross-carrier scheduling;
periodic tracking reference signal (P-TRS)-based paging; and
paging early indication (PEI)-based paging.

6. A power transfer method to be carried out by a terminal, the method comprising:
a step of receiving, from a base station, an indication related to power transfer;
a step of receiving wireless power transfer, according to the indication related to power transfer; and
a step of determining, according to a function to reduce power consumption, whether or not to carry out an operation related to power transfer.
